(19) United States
(12) Patent Application Publication
(10) Pub. No.: US 2016/0305602 A1
(43) Pub. Date: Oct. 20, 2016

(54) A Stabilizer

(71) Applicant: SHADOWCAM LIMITED, Margate, Kent (GB)

(72) Inventor: Scott Carthey, Kent (GB)

(21) Appl. No.: 15/038,686

(22) PCT Filed: Oct. 17, 2014
(86) PCT No.: PCT/EP2014/072377

§ 371 Date: May 23, 2016

(30) Foreign Application Priority Data
Oct. 18, 2013 (GB) 1318495.7
Jun. 19, 2014 (GB) 1410938.3

(51) Int. Cl. F16M 11/20; F16M 11/04; F16M 11/18; F16M 13/04

(52) U.S. Cl. CPC F16M 11/2035; F16M 13/04; F16M 11/046; F16M 11/048; F16M 11/18; F16M 2200/041; F16M 2200/047; F16M 2200/063

(57) ABSTRACT

A stabiliser for a camera mount, the stabiliser including a vertical movement stabiliser assembly having a first pair of vertically spaced, co-terminus parallel arms, and a second pair of vertically spaced, co-terminus parallel arms. A connecting bracket is pivotally coupled to the distal end of the first pair of arms and pivotally coupled to the proximal end of the second pair of arms. The two pair of arms are biased to a rest configuration to achieve a damping effect which counters or smooths vertical movement of the stabilizer.

The present invention relates to a stabiliser for use in stabilising a camera mount. In particular, the stabiliser cancels or smoothes vertical movement or displacement of the camera mount.

Apparatus to stabilise a camera mount are known. In one example, a user wears a vest or jacket which has secured to one side of it an apparatus to stabilise a camera mount. The apparatus includes a number of arms which are variously hinged and which traverse from one side of the user's body to the other, wherein the camera mount is located at the distal end of the arm arrangement. This arrangement is both very bulky and relatively heavy for the user to carry. In addition, the vest or jacket to which the arm arrangement is secured is not universal in its size, so different sizes must be provided to allow for different size users.

As an alternative, a 3-axis gimbal camera stabilisation system is known. However, although such an arrangement is able to stabilise a camera mount against rotation in three mutually orthogonal axes, it is unable to stabilise the camera mount against vertical or lateral displacement. Thus, when a camera is carried by a user, the vertical displacement of the camera mount as the user moves is not countered or corrected. Similarly, lateral movement (e.g. in a horizontal plane) of the camera mount by the user is not corrected or countered. In addition, the known 3-axis gimbal apparatus tend to have a handle arrangement which locates the camera mount significantly below the shoulder height/eyeline of the user.

The present invention sets out to address the problems associated with known camera stabilisation systems.

According to a first aspect of the invention, there is provided a stabiliser for stabilising a camera mount, the stabiliser including a vertical movement stabiliser assembly comprising a first pair of vertically spaced parallel arms, the parallel arms being co-terminus and having a proximal end and a distal end; a second pair of vertically spaced parallel arms, the parallel arms being co-terminus and having a proximal end and a distal end; and a connecting bracket pivotally coupled to the distal end of the first pair of arms and pivotally coupled to the proximal end of the second pair of arms, wherein the vertical movement stabiliser assembly has a first configuration in which the first pair of arms, the connecting bracket and the second pair of arms are all substantially aligned with each other; the connecting bracket extends from the distal end of the first pair of arms towards the proximal end of the first pair of arms; a portion of the first pair of arms is located adjacent to a portion of the second pair of arms with the bracket located therebetween; and the distal end of the second pair of arms extends beyond the distal end of the first pair of arms; wherein the vertical movement stabiliser has a second configuration in which the first pair of arms and the second pair of arms are parallel to each other, but out of alignment with each other; and wherein the first pair of arms includes a first biasing element, the second pair of arms includes a second biasing element, and the first and second biasing elements are arranged to bias the vertical movement stabiliser assembly to a rest configuration.

The arrangement of two pairs of parallel, vertically spaced arms connected via a bracket and biased to a rest configuration achieves a damping effect which counters or smoothes vertical movement of the stabiliser. Furthermore, by arranging the first pair of arms, the connecting bracket and the second pair of arms in an optional Z-type configuration, the stabiliser has a very compact arrangement.

It will be appreciated that the terms “vertical movement” and “vertical motion” refers to an “up and down” motion or displacement in a vertical plane.

In an embodiment of the invention, the rest configuration is the first configuration.

Suitably, the biasing elements are helical springs. In this embodiment, as the first and second pairs of arms are urged into an extended configuration by vertical displacement of the stabiliser, the helical springs are extended and a restorative force is exerted by the springs on the arms.

As will be appreciated, camera mounts can be used for relative light cameras as well as relatively heavy cameras. In order to provide an appropriate restorative force for cameras or camera equipment of different weights, at least one of the biasing elements may be adjustable such that it can exert different, pre-determined restorative forces.

In an embodiment of the invention, the stabiliser includes a third pair of vertically spaced parallel arms, the parallel arms being co-terminus and having a proximal end and a distal end, the third pair of arms being arranged in a parallel spaced relationship with the first pair of parallel arms whereby the first pair of arms and the third pair of arms define a gap therebetween; and wherein the bracket is located within the gap when the vertical movement stabiliser assembly is in its rest position.

The inclusion of the third pair of arms in a spaced relationship (typically, horizontally spaced from) with the first pair of arms provides additional strength and stability for the vertical movement stabiliser assembly.

In embodiments which include a third pair of arms, the third pair of arms may include a third biasing element. The third biasing element operates in concert with the first biasing element to provide an additional restorative force. The third biasing element may have the same or similar features as the first biasing element. Thus, it may be in the form of a helical spring and it may be adjustable to provide a variable, pre-determined restorative force.

The provision of a third pair of arms allows for the connecting bracket to be substantially U-shaped. In this form, one of the opposed arms may be pivotally coupled to the distal end of the first pair of arms and the other of the opposed arms may be pivotally coupled to the distal end of the third pair of arms.

In a further embodiment of the invention, the stabiliser includes a fourth pair of vertically spaced parallel arms, the parallel arms being co-terminus and having a proximal end and a distal end, the fourth pair of arms being arranged in a parallel spaced relationship with the second pair of parallel arms; the connecting bracket is substantially U-shaped; and the second and fourth pairs of arms are located within a gap defined by the opposing arms of the connecting bracket when the vertical movement stabiliser assembly is in its rest position.

In such an embodiment, the U-shaped connecting bracket is sandwiched between the first and third pairs of arms located adjacent to the outwardly facing surfaces of the bracket and the second and fourth pairs of arms located adjacent to the inwardly facing surfaces of the bracket.

The vertical movement stabiliser assembly as defined hereinabove counters or damps vertical motion of the stabiliser. However, it is also desired to counter rotation of the stabiliser about any one or more of three mutually orthogonal axes. These axes are often referred to as the X, Y and Z axes or the pitch, roll and yaw axes. Accordingly, the distal end of the second pair of arms (and optionally also the distal end of the fourth pair of arms, where present) may be connected to a 3-axis gimbal assembly which is arranged to counter rotation of the stabiliser in three mutually orthogonal axes.

Suitably, the 3-axis gimbal assembly includes three rotary actuators, wherein each actuator is arranged to rotate about a respective one of the mutually orthogonal axes.

In such an arrangement, the stabiliser may include a sensor which is adapted or configured to sense rotation of the stabiliser about the three axes. The sensor may comprise a single sensor element, two sensor elements or three sensor elements, for example.

In embodiments which include rotary actuators and a sensor element, the stabiliser suitably further includes a controller, wherein the sensor may be connected to an input of the controller, each of the rotary actuators may be connected to an output of the controller and the controller is arranged to energise one or more of the actuators in response to a signal from the sensor. Thus, if the stabiliser rotates about one of the axes, the sensor senses the rotation and sends a signal to the controller. The controller determines the extent and sense of the rotation and transmits an output signal to the relevant rotary controller to counter the rotation by rotating in the opposite sense to the same degree.

In addition to the rotary actuators responding to changes in the orientation of the stabiliser, they may also be controlled to rotate in accordance with a separate input command. Thus, the stabiliser may further include a remote control apparatus, wherein the remote control apparatus is connected to a second input of the controller and the controller transmits a control signal to one or more of the rotary actuators in response to input signals from the remote control apparatus.

It will be appreciated that the controller, the sensor and/or the rotary actuators need to be powered. Accordingly, the stabiliser suitably includes an electrical power source, such as one or more batteries. The electrical power source is typically electrically connected to the controller and the rotary actuators, although in addition, it may optionally be connected to the sensor.

In order that the three rotary actuators are able to rotate about their respective axes, the 3-axis gimbal assembly may include one or more frame elements located between each of the rotary actuators, wherein the frame elements connect the rotary actuators and maintain them in the correct orientation.

At the opposite end of the 3-axis gimbal assembly to the vertical movement stabiliser assembly is suitably located a camera mount receiver in the form of a pair of parallel spaced apart receiver arms. In use, the vertical movement stabiliser assembly and the 3-axis gimbal assembly cooperate to maintain the camera mount receiver in a fixed orientation relative to the horizontal and vertical planes, irrespective of the motion of the stabiliser and the user.

The camera mount receiver is configured to receive standard camera mounts. Accordingly, in an embodiment of the invention, the stabiliser includes a camera mount carried by the camera mount receiver.

As a camera may be secured to the camera mount in an offset arrangement (i.e. the camera is not located centrally on the camera mount), the camera mount suitably includes an adjuster which allows the camera to be mounted centrally relative to the camera mount receiver. Thus, the adjuster permits the camera mount to be displaced relative to the camera mount receiver. Such displacement is typically within a plane, for example within a horizontal plane.

As the camera mount receiver is maintained in a substantially fixed orientation, it is useful to be able to orient the receiver in a desired orientation in order that this may be defined by the controller as the fixed or reference orientation. In connection with this, the camera mount receiver may include an orientation indicator, such as a spirit level or bubble level. This allows the camera mount receiver to be oriented in the desired orientation, which is then defined as the fixed orientation by the controller.

It may be desirable to maintain the vertical movement stabiliser assembly in a fixed orientation. Accordingly, the vertical movement stabiliser assembly may include a lock, wherein the lock has a first configuration in which the stabiliser assembly is free to move in a vertical plane as discussed above, and a second, locked configuration, in which the stabiliser assembly is prevented from displacement in a vertical plane.

The stabiliser is typically held by an operator or user, either directly or via an extension boom or a shoulder rig, or it may be fixed to a vehicle, such as a land vehicle, an aquatic vehicle or aerial vehicle. Therefore, in an embodiment of the invention, the proximal end of the first pair of arms (and also optionally the proximal end of the third pair of arms, where present) is connected directly or indirectly to a handle assembly. The handle assembly may be directly grasped by a user, it may receive an extension boom or a shoulder rig, or it may be used to secure the stabiliser to a vehicle.

In order that the stabiliser may also damp or counter horizontal displacement of the stabiliser, the proximal end of the first pair of arms may be rotatably coupled to the handle assembly, whereby the vertical movement stabiliser assembly is rotatable relative to the handle assembly. In this embodiment, lateral movement of the stabiliser (i.e. displacement of the stabiliser within a substantially horizontal plane) is manifested in a rotation of the vertical movement stabiliser assembly about the handle assembly.

Suitably, the handle assembly includes a substantially vertical component and the vertical movement stabiliser assembly is rotatable about the vertical component, such that the axis of rotation is substantially vertical and the vertical movement stabiliser assembly rotates within a substantially horizontal plane.

As with the vertical movement stabiliser assembly, the rotatable coupling suitably also includes one or more biasing elements arranged to bias the vertical movement stabiliser assembly to a rotational rest position relative to the handle assembly. As the rotation of the vertical movement stabiliser assembly relative to the handle assembly may be in one of two senses (nominally clockwise and anti-clockwise), two opposing bias elements may be provided whereby the biasing forces exerted by each of the biasing elements cancels out at the rest position.

The inertia of the vertical movement stabiliser assembly may vary according to its configuration and the weight of a camera being carried by it. Accordingly, the or each biasing element associated with the rotatable coupling may be adjustable to provide a pre-determined restorative force.

In a further embodiment of the invention, the rotatable coupling may include a rotational lock which has a first configuration in which the rotatable coupling is free to rotate, and a second locked configuration in which the rotatable coupling is prevented from rotating relative to the handle.

It will be appreciated from the foregoing that as well as direct manipulation by a user, the stabiliser of the present invention may connected to an extension boom or it may be secured to a vehicle. Thus, the handle assembly may include an accessory mounting plate to which may be secured an extension boom, a shoulder rig, a vehicle rig and/or other accessories commonly associated with cameras. Additionally or alternatively, the handle assembly may include a socket or define an aperture which may be used to secure the handle assembly to an extension boom or a vehicle rig.

It will be appreciated that the accessory mounting plate may carry the sensor, controller and/or electrical power source, where present. The accessory mounting plate may also carry a monitor.

In an embodiment of the invention, the distal end of the second pair of arms is connected to a 3-axis gimbal assembly; the 3-axis gimbal assembly includes three rotary actuators, wherein each actuator is arranged to rotate about a respective one of the mutually orthogonal axes; the 3-axis gimbal assembly includes one or more frame elements located between each of the rotary actuators, wherein the frame elements connect the rotary actuators and maintain them in their correct orientation; the proximal end of the first pair of arms is connected directly or indirectly to a handle assembly; and wherein the frame elements and the handle assembly are both hinged such that the stabiliser has an operational configuration and a storage configuration, wherein in the storage configuration, the stabiliser folds substantially flat.

Camera equipment is often bulky and cumbersome to transport. Therefore, the ability to be able to fold flat the stabiliser for storage is useful. In this context, it will be appreciated that the operational configuration refers to a configuration in which the three rotary actuators are arranged to rotate about their respective axes.

According to a second aspect of the invention, there is provided a stabilised camera mount including a camera mount arranged to receive a camera, wherein the camera mount is coupled to a stabiliser as defined anywhere herein.

According to a third aspect of the invention, there is provided a stabilised camera system including a camera secured to a stabilised camera mount according to the second aspect of the invention.

In this aspect of the invention, the camera may be a still camera, such as an SLR camera, or it may be a video camera.

In an embodiment of this aspect of the invention, the camera system may include a monitor carried by the stabilised camera mount.

In a further embodiment of the invention, the stabilised camera mount is hinged such that it has an operational configuration and a storage configuration, wherein in the storage configuration, the stabilised camera mount is in a substantially flat configuration and the camera is secured to the camera mount. Where present, the monitor may also remain secured to the stabilised camera mount.

The ability to configure the stabilised camera mount into a storage configuration with the camera, and optionally a monitor, secured to the mount is useful in reducing the time needed to reconfigure the camera system into an operational configuration.

It will be appreciated that the connecting bracket and the second pair of spaced parallel arms may be replaced with a rotational motor and an orientation sensor arrangement. Accordingly, a fourth aspect of the invention provides a stabiliser for a camera mount including a vertical movement stabiliser and a mounting arm, the vertical movement stabiliser comprising a control arm; a rotary actuator located at one end of the control arm; an orientation sensor; and a controller connected to the motor and the orientation sensor, wherein the rotational motor is arranged to rotate in a vertical plane; the orientation sensor is adapted to detect a change in a vertical orientation of the motor; and the controller is programmed to control the rotation of the motor such that the mounting arm is maintained in a plane which is parallel to a reference plane. Thus, the vertical movement stabiliser may maintain the mounting arm in a substantially horizontal plane, for example.

The rotary actuator may be located at the proximal end of the control arm or at the distal end of the control arm. In an embodiment of the invention, the control arm includes a rotary actuator located at each end of the control arm.

The control arm may comprise a pair of vertically spaced parallel arms which are co-terminus.

The invention of the fourth aspect may include one or more of the optional features and/or elements described and defined hereinabove with respect to the first aspect of the invention.

A fifth aspect of the invention provides a stabilised camera mount including a handle, a mounting arm and a horizontal stabiliser, wherein the horizontal stabiliser is located between the mounting arm and the handle and permits the mounting arm to pivot about the handle, the horizontal stabiliser including one or more biasing elements and having a rest configuration and a displaced configuration, wherein the biasing element biases the mounting arm to the rest configuration.

In an embodiment of the invention according to the fifth aspect, the stabilised camera mount includes a 3-axis gimbal assembly as defined anywhere herein, the 3-axis gimbal assembly being carried by the distal end of the mounting arm.

In a further embodiment of the invention, the or each biasing element comprises a spring, suitably a helical spring.

The fifth aspect of the invention may include one or more of the optional features and/or elements described and defined hereinabove with respect to the first aspect of the invention or it may be combined with the fourth aspect of the invention and embodiments thereof.

In order to make the stabiliser assembly of any aspect of the invention easier to balance, it may include a 2-dimensional adjustment bracket. Conventionally, a camera is balanced on a stabilised mount by making various 1-dimensional adjustments to the location of the camera in relation to the stabiliser system and also to the stabiliser system itself. These various adjustments can be time consuming to make and stabilised camera mounts are often difficult to balance. However, it has been found that a two dimensional adjustment bracket makes it quicker and easier to balance a camera on a stabilised mount.

According to a sixth aspect of the invention, there is provided a stabilised camera mount including a stabiliser assembly, a mounting bracket for a camera and a 2-dimensional adjustment bracket arranged to balance the mounting bracket relative to the stabiliser assembly, wherein the stabiliser assembly is adapted to maintain the mounting bracket in a plane parallel to a reference plane and the adjustment bracket includes a first element which defines one or more tracks and a second element which includes a locating portion adapted to be secured within the track, wherein the first element of the adjustment bracket has an X axis which lies parallel to the roll axis of the stabiliser assembly and has a Y axis which lies parallel to the pitch axis of the stabiliser assembly and the or at least one of the tracks is angled with respect to the X and Y axes.

In known stabilised camera mounts, separate X and Y axis adjustments are provided. However, it has been found that these can be combined into a single adjustment bracket as defined herein. This makes the task of balancing the camera much easier.

Suitably, the or at least one of the tracks is linear and is arranged at an angle of between 1° and 89°, for example 30° and 60° to the X axis and between 1° and 89°, for example 30° and 60°, to the Y axis.

The stabiliser assembly of the sixth aspect of the invention may be a 3-axis gimbal stabiliser assembly or it may be a stabiliser assembly as defined in any of the first to fifth aspects of the invention.

The sixth aspect of the invention may include any of the optional features or components described hereinabove with reference to the first to fifth aspects of the invention.

The skilled person will appreciate that the features described and defined in connection with the aspects of the invention and the embodiments thereof may be combined in any combination, regardless of whether the specific combination is expressly mentioned herein. Thus, all such combinations are considered to have been made available to the skilled person.

An embodiment of the invention will now be described, by way of example only, with reference to the accompanying drawings in which:

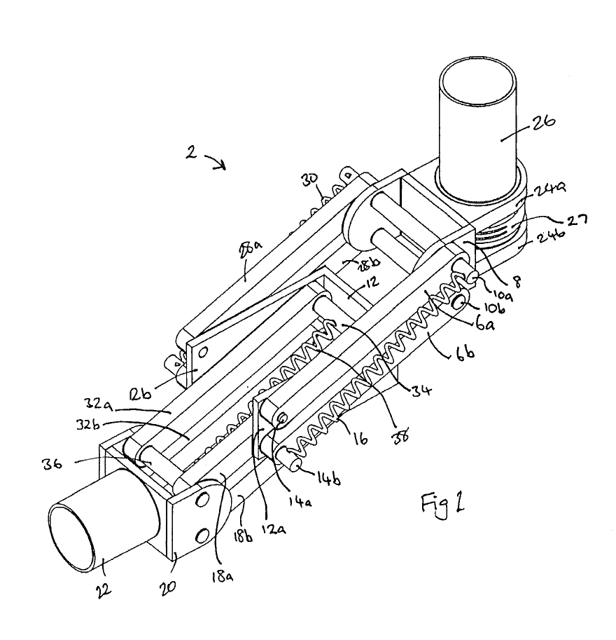

FIG. 1 is perspective view of a vertical movement stabiliser assembly according to the first aspect of the invention;

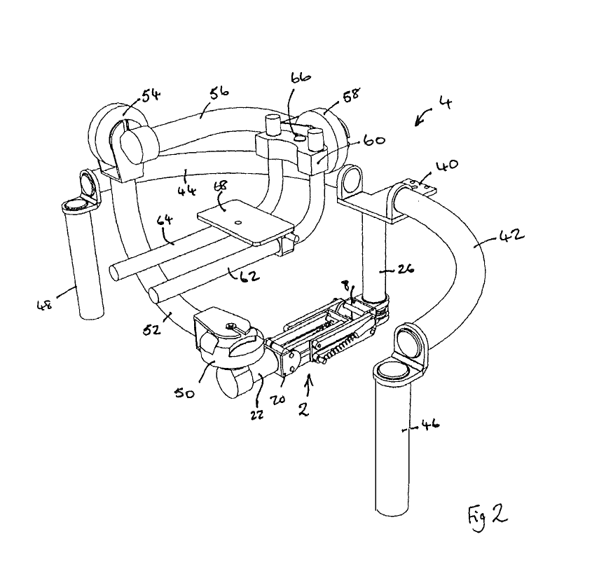

FIG. 2 is a perspective view of a stabiliser according to the invention, including the vertical movement stabiliser assembly of FIG. 1;

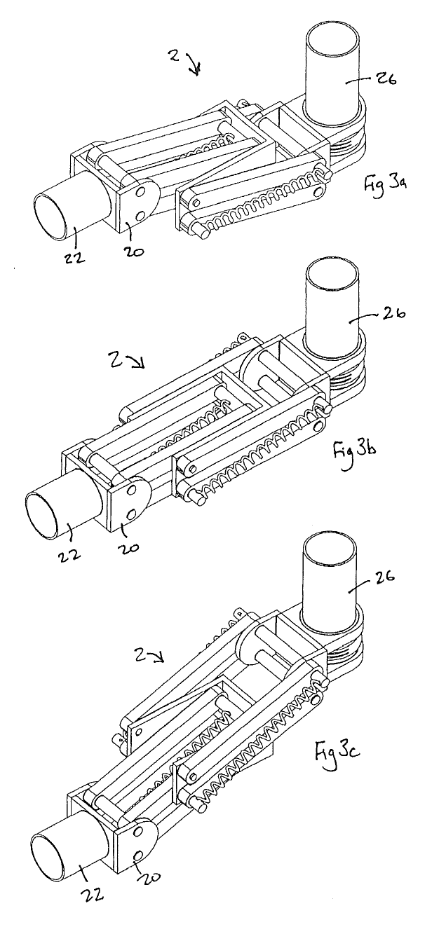

FIGS. 3a, 3b and 3c are perspective views of the assembly shown in FIG. 1 in different configurations;

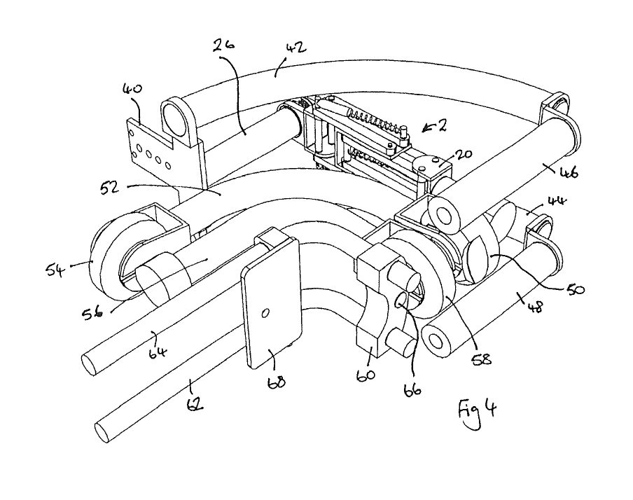

FIG. 4 is a perspective view of the stabiliser in its storage configuration;

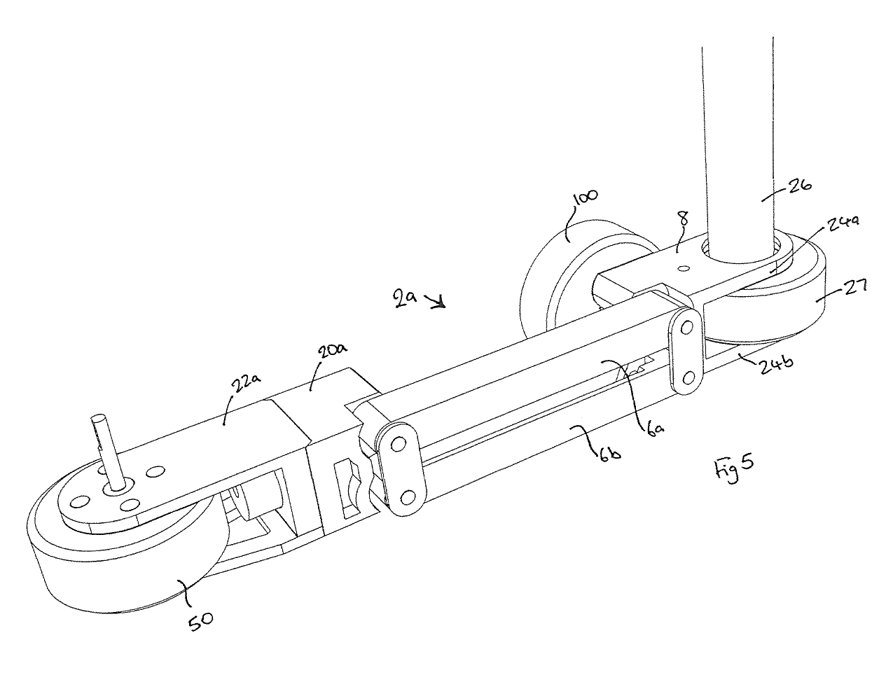

FIG. 5 is a perspective view of a vertical movement stabiliser assembly according to the fourth aspect of the invention;

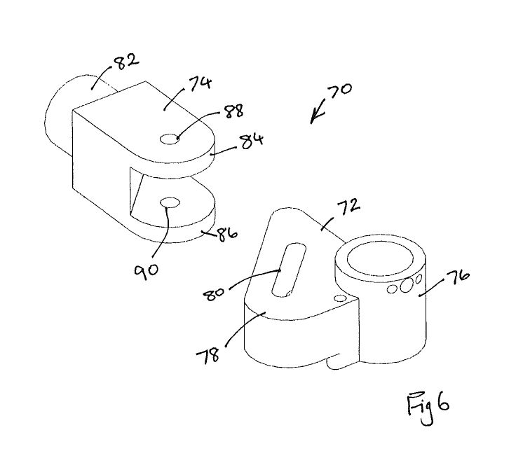

FIG. 6 is an exploded perspective view of a 2D adjustment bracket according to the sixth aspect of the invention; and

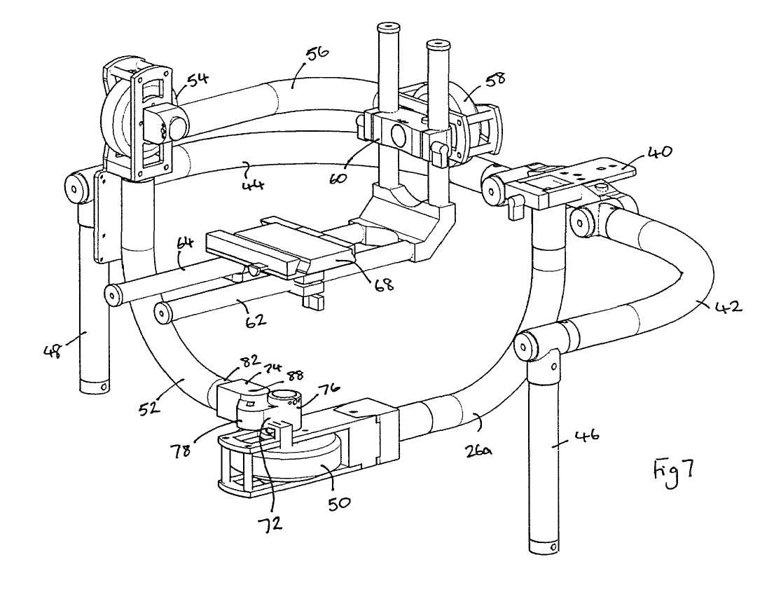

FIG. 7 is a perspective view of a stabiliser including the 2D adjustment bracket of FIG. 6.

For the avoidance of doubt, the skilled person will appreciate that in this specification, the terms “up”, “down”, “front”, “rear”, “upper”, “lower”, “width”, etc. refer to the orientation of the components as found in the example when configured for normal use as shown in the Figures.

FIG. 1 shows a vertical movement stabiliser assembly 2 which forms part of a stabiliser 4 (shown in FIG. 2). The vertical movement stabiliser assembly 2 comprises a first pair of arms 6a, 6b which are co-terminus (i.e. equal in length) and which are vertically spaced apart. The proximal ends of the first arms 6a, 6b are pivotally coupled to a handle bracket 8 via pins 10a, 10b. The distal ends of the first arms 6a, 6b are pivotally coupled to a first end of a connecting bracket 12 via pins 14a, 14b.

The pins 10a and 14b extend away from the first arms 6a, 6b and are connected by a helical spring 16.

The connecting bracket 12 is U-shaped and has opposed legs 12a, 12b.

The first leg 12a of the connecting bracket 12 extends from the distal ends of the first arms 6a, 6b towards the proximal ends of the first arms 6a, 6b, but is arranged to be shorter than the first arms 6a, 6b. To the other end of the connecting bracket is pivotally connected the proximal ends of a second pair of arms 18a, 18b. The second pair of arms 18a, 18b is arranged similarly to the first pair of arms 6a, 6b in the sense that they are co-terminus and vertically spaced.

This arrangement of the first arms 6a, 6b and the second arms 18a, 18b results in the arms being maintained in a parallel relationship and extending in the same direction (the direction being defined as from the proximal end to the distal end).

The distal ends of the second arms 18a, 18b are pivotally connected to a gimbal bracket 20 which has extending therefrom a tubular connector 22.

The handle bracket 8 includes a pair of bearing elements 24a, 24b projecting away from the first arms 6a, 6b. The bearing elements 24a, 24b define bearing apertures therein which rotatably receive therein a handle tube element 26.

Located between the bearing elements 24a, 24b is a torsion spring system 27 including a pair of opposed torsion springs which cancel each other out at a rest position and one of the springs will exert a restorative force when the vertical movement stabiliser assembly 2 is rotationally displaced relative to the handle tube element 26.

The vertical movement stabiliser assembly 2 is arranged such that when the handle tube element 26 is vertical, the legs 12a, 12b of the connecting bracket 12 and the tubular connector 22 of the gimbal bracket 20 are maintained horizontal.

A third pair of arms 28a, 28b is provided opposite to and spaced from the first pair of arms 6a, 6b. The third pair of arms 28a, 28b mirrors the first pair of arms 6a, 6b. The proximal ends of the third arms 28a, 28b are pivotally connected to the handle bracket 8 and the distal ends of the third arms 28a, 28b are pivotally connected to the leg 12b of the connecting bracket 12. As shown in FIG. 1, the pins 10a, 10b extend through the handle bracket 8 and pivotally secure the proximal ends of both the first arms 6a, 6b and the third arms 28a, 28b to the handle bracket 8.

The third pair of arms 28a, 28b includes a respective helical spring, which is arranged in the same way as the helical spring 16.

In this arrangement, the first pair of arms 6a, 6b and the third pair of arms 28a, 28b move in concert and the helical springs 16, 30 bias the first and third arms 6a, 6b, 28a, 28b to a configuration which is substantially perpendicular to the handle tube element 26.

A fourth pair of arms 32a, 32b is provided opposite to and spaced from the second pair of arms 18a, 18b. The fourth pair of arms 32a, 32b mirrors the second pair of arms 18a, 18b. The proximal ends of the fourth arms 32a, 32b are pivotally connected to the connecting bracket 12 and their distal ends are pivotally connected to the gimbal bracket 20.

An upper elongate pin 34 pivotally connect the upper arms 18a, 32a to the connecting bracket 12 and an upper elongate pin 36 pivotally connects the upper arms 18a, 32a to the gimbal bracket 20. A corresponding arrangement of lower elongate pins (not shown) pivotally connects the bottom arms 18b, 32b to the connecting bracket 12 and the gimbal bracket 20. A further helical spring 38 is connected between the upper elongate pin 34 and the lower elongate pin which connects bottom arms 18b, 32b to the gimbal bracket 20. As with the helical springs 16, 30, the helical spring 38 biases the second and fourth arms 18a, 18b, 32a, 32b to a configuration which is substantially perpendicular to the handle tube element 26.

FIG. 2 shows the stabiliser apparatus 4. In the stabiliser apparatus 4, the vertical movement stabiliser assembly 2 is secured at handle bracket end to the handle tube element 26. The handle tube element 26 terminates at its opposite end in a mounting plate 40 which defines a number of apertures to which various components such as a controller, monitor and battery pack can be secured. Extending substantially horizontally from either side of the mounting plate 40 are handle frame elements 42, 44 which have respective user grip members 46, 48 hingedly connected to each end of them.

A 3-axis gimbal assembly is connected to the gimbal bracket 20 via the tubular connector 22.

The 3-axis gimbal assembly includes a first rotary actuator 50 connected to the tubular connector 22. In the arrangement shown in FIG. 2, the first rotary actuator compensates for rotation of the handle assembly 42, 44, 46, 48 about a Z or yaw axis.

A first frame element 52, which is curved through 90° connects the first rotary actuator 50 to a second rotary actuator 54. The second rotary actuator 54 compensates for rotation of the handle assembly 42, 44, 46, 48 about an X or pitch axis.

A second frame element 56, which is also curved through 90°, connects the second rotary actuator 54 to a third rotary actuator 58. The third rotary actuator 58 compensates for rotation of the handle assembly 42, 44, 46, 48 about a Y or roll axis.

Connected to the third rotary actuator is a camera mount receiver bracket 60. A pair of camera mount receiver arms 62, 64 extend from the camera mount receiver bracket 60. The arms 62, 64 curve through 90° and project forwards, with the forward projecting portions of the arms at roughly the same height as the handle frame elements 42, 44.

The camera mount receiver bracket 60 includes a two-dimensional spirit level 66 which allows a user to determine when the forward projecting portions of the arms 62, 64 are horizontal.

The camera mount receiver arms 62, 64 carry thereon a camera mount 68 which is arranged to securely receive thereon a camera. The camera mount 68 is adjustable in a lengthwise direction relative to the arms 62, 64 and also in a lateral direction relative to the arms 62, 64. The lengthwise adjustment is obtained by varying the position on the arms at which the camera mount 68 is secured. The lateral adjustment is obtained via a fixed screw arrangement (not shown).

The skilled person will appreciate that the rotary actuators 50, 54, 58 are powered by an electrical power source (not shown) and controlled by a controller (not shown). The controller receives inputs from three sensors elements (not shown), each of which senses rotation about one of the three orthogonal axes (yaw, pitch and roll or Z, X and Y) and transmits control signals to the respective rotary actuators to counter the sensed rotation. In this way, the camera mount 68 remains in a substantially fixed orientation, regardless of any rotation of the handle assembly.

The vertical movement stabiliser assembly 2 counters vertical motion of the handle assembly 42, 44, 46, 48. This is shown in FIGS. 3a, 3b and 3c. FIG. 3b shows the vertical movement stabiliser assembly 2 in a rest position. FIG. 3a shows the vertical movement stabiliser assembly 2 in a configuration following a downwards displacement of the handle tube element 26. In this Figure, it can be seen that the tubular connector 22 of the gimbal bracket 20 remains in substantially the same horizontal plane as shown in FIG. 3b. Finally, FIG. 3c shows the vertical movement stabiliser assembly 2 in a configuration following an upwards displacement of the handle tube element 26. Again, the tubular connector 22 of the gimbal bracket 20 remains in substantially the same horizontal plane as shown in FIG. 3b.

FIG. 4 shows the stabiliser apparatus 4 in a storage configuration. As shown in this Figure, the stabiliser apparatus 4 folds substantially flat in this configuration. This is achieved by having the handle frame elements 42, 44 hingedly connected to the accessory plate 40

In an alternative embodiment, the handle frame elements 42, 44 are detachable from the accessory plate 40.

FIG. 5 shows a vertical movement stabiliser assembly 2a according to the fourth aspect of the invention. In this embodiment, the handle bracket 8 is rotationally coupled to the handle tube element 26. The handle bracket 8 includes a pair of bearing elements 24a, 24b projecting towards the handle tube element 26. The bearing elements 24a, 24b define bearing apertures therein which rotatably receive therein a handle tube element 26. Located between the bearing elements 24a, 24b is a torsion spring system 27 including a pair of opposed torsion springs which cancel each other out at a rest position and one of the springs will exert a restorative force when the vertical movement stabiliser assembly 2a is rotationally displaced relative to the handle tube element 26.

A pair of parallel, vertically spaced arms 6a, 6b are pivotally coupled to the handle bracket 8. However, in this embodiment, the displacement of the distal ends of the arms 6a, 6b in a vertical plane is controlled by a rotary actuator 100, which is operably connected to the proximal ends of the arms 6a, 6b. The rotary actuator 100 includes a positional sensor (not shown) and a controller (also not shown) that together operate the rotary actuator 100 in response to changes in the vertical position of the sensor.

A gimbal bracket 20a is pivotally coupled to the distal ends of the arms 6a, 6b such that the orientation of the gimbal bracket 20a remains parallel to the orientation of handle bracket 8. The gimbal bracket 20a is connected to a housing 22a for the rotary actuator 50. It will be appreciated that a 3-axis gimbal assembly as shown in FIGS. 2 and 7 may be connected to the vertical movement stabiliser assembly 2a.

FIG. 6 shows an adjustment bracket 70 which includes a fixed element 72 and a movable element 74. The adjustment bracket may be used in an embodiment of the invention shown in FIG. 7. In this embodiment, the bracket is located between the rotary actuator 50 and the first frame element 52. The fixed element 72 includes a cylindrical mounting portion 76 which is adapted to be mounted onto a post extending from the rotary actuator 50 and a body portion 78 which extends radially from the cylindrical mounting portion 76. The body portion 78 defines a linear track in the form of a channel 80 which extends through the body portion 78. The channel 80 is arranged to be angled with respect to both an X axis defined as an axis which lies parallel to the roll axis of the stabiliser assembly, and a Y axis defined as an axis which lies parallel to the pitch axis of the stabiliser assembly. In this embodiment, the channel 80 is angled at 46° to the X axis. However, the angle of the channel can be varied to allow different assemblies to be balanced. For example, a different angle may be desired if rotary actuators of a different type are used or if the frame elements are of different lengths.

The movable element 74 includes a cylindrical projection 82 and a pair of spaced apart arms 84, 86 extending axially therefrom. The cylindrical projection is adapted to be secured within the first frame element 52. The spaced apart arms 84, 86 define a gap therebetween which is sized to receive therein the body portion 78 of the fixed element 72. Each of the arms 84, 86 defined therethrough a bore 88, 90 and the bores are vertically aligned. A bolt (not shown) passes through the first bore 88, the channel 80 and the second bore 90 to secure the movable element 74 to the fixed element 72. The bolt is retained in place by a wing nut (also not shown). A user is able to adjust the position of the first frame element 52 relative to the rotary actuator 50 by loosening the wing nut, sliding the movable element 74 relative to the fixed element 72 along the channel 80 to a desired location and then tightening the wing nut. Displacement of the movable element 74 along the channel 80 results in a 2-dimensional displacement of the first frame element 52 relative to the rotary actuator 50, which in turn results in an easier adjustment of the stabiliser assembly.

FIG. 7 shows a stabiliser assembly having the same components as shown in FIG. 2, but where the vertical movement stabiliser assembly 2 is omitted. In this embodiment, the elements corresponding to the similar elements in FIG. 2 are given the corresponding reference numerals. The major difference between the stabiliser assembly shown in FIG. 2 and the stabiliser assembly shown in FIG. 7 is that the handle tube element 26, the vertical movement stabiliser assembly 2 and the tubular connector 22 are replaced with a curved arm 26a and the 2D adjuster 70 shown in FIG. 6 is coupled to the first rotary actuator 50, between the rotary actuator 50 and the first frame element 52.

In use, the stabiliser apparatus 4 is arranged in its operative configuration (FIG. 2) and a camera is attached to the camera mount 68. The stabiliser 4 is oriented such that the camera is horizontal according to the spirit level 66. This is then defined as the base orientation of the camera and the controller is set accordingly. Once activated, any yaw of the handle assembly about a Z axis will be corrected by the first rotary actuator 50 such that the camera is maintained in its base orientation. Any pitch of the handle assembly about an X axis will be corrected by the second rotary actuator 54 and any roll of the handle assembly about a Y axis will be corrected by the third rotary actuator 58.

In addition, any vertical displacement of the handle tube element 26, for example as a result of vertical movements by the user, is corrected or damped by the vertical movement stabiliser assembly 2. Similarly, any lateral movement by the user are corrected or damped are manifested by rotation of the vertical movement stabiliser assembly 2 relative to the handle tube element 26. Such manifestations of the lateral movement are countered or damped by the torsion spring system 27 located between the bearing elements 24a, 24b.

Thus, the stabiliser apparatus is able to counter and/or damp vertical displacement, horizontal displacement and/or rotational displacement about any of the yaw, pitch and roll axes.

1. A stabiliser for a camera mount, the stabiliser including a vertical movement stabiliser assembly comprising a first pair of vertically spaced parallel arms, the parallel arms being co-terminus and having a proximal end and a distal end; a second pair of vertically spaced parallel arms, the parallel arms being co-terminus and having a proximal end and a distal end; and a connecting bracket pivotally coupled to the distal end of the first pair of arms and pivotally coupled to the proximal end of the second pair of arms, wherein the vertical movement stabiliser assembly has a first configuration in which the first pair of arms, the connecting bracket and the second pair of arms are all substantially aligned with each other; the connecting bracket extends from the distal end of the first pair of arms towards the proximal end of the first pair of arms; a portion of the first pair of arms is located adjacent to a portion of the second pair of arms with the bracket located therebetween; and the distal end of the second pair of arms extends beyond the distal end of the first pair of arms; wherein the vertical movement stabiliser has a second configuration in which the first pair of arms and the second pair of arms are parallel to each other, but out of alignment with each other; and wherein the first pair of arms includes a first biasing element, the second pair of arms includes a second biasing element, and the first and second biasing elements are arranged to bias the vertical movement stabiliser assembly to a rest configuration.

2. A stabiliser according to claim 1, wherein the biasing elements are helical springs.

3. A stabiliser according to claim 1, wherein at least one of the biasing elements is adjustable to provide a pre-determined restorative force.

4. A stabiliser according to claim 1, wherein the vertical movement stabiliser assembly includes a third pair of vertically spaced parallel arms, the parallel arms being co-terminus and having a proximal end and a distal end, the third pair of arms being arranged in a parallel spaced relationship with the first pair of parallel arms whereby the first pair of arms and the third pair of arms define a gap therebetween; and wherein the bracket is located within the gap when the vertical movement stabiliser assembly is in its rest position.

5. A stabiliser according to claim 4, wherein the third pair of arms includes a third biasing element.

6. A stabiliser according to claim 4, wherein the stabiliser includes a fourth pair of vertically spaced parallel arms, the parallel arms being co-terminus and having a proximal end and a distal end, the fourth pair of arms being arranged in a parallel spaced relationship with the second pair of parallel arms; the connecting bracket is substantially U-shaped; and the second and fourth pairs of arms are located within a gap defined by the opposing arms of the connecting bracket when the vertical movement stabiliser assembly is in its rest position.

7. A stabiliser according to claim 1, wherein the distal end of the second pair of arms is connected to a 3-axis gimbal assembly which is arranged to counter rotation of the stabiliser in three mutually orthogonal axes.

8. A stabiliser according to claim 7, wherein the 3-axis gimbal assembly includes three rotary actuators, wherein each actuator is arranged to rotate about a respective one of the mutually orthogonal axes.

9. A stabiliser according to claim 8, wherein the stabiliser further includes a sensor adapted to sense rotation of the stabiliser about the three mutually orthogonal axes.

10. A stabiliser according to claim 9, wherein the stabiliser further includes a controller, wherein the sensor is connected to an input of the controller, each of the rotary actuators is connected to an output of the controller and the controller is arranged to energise one or more of the actuators in response to a signal from the sensor.

11. A stabiliser according to claim 10, wherein the stabiliser further includes a remote control apparatus and the remote control apparatus is connected to a second input of the controller.

12. A stabiliser according to claim 8, wherein the stabiliser includes an electrical power source electrically connected to each of the rotary actuators.

13. A stabiliser according to claim 8, wherein the 3-axis gimbal assembly includes one or more frame elements located between each of the rotary actuators, wherein the frame elements connect the rotary actuators and maintain them in the correct orientation.

14. A stabiliser according to claim 8, wherein the 3-axis gimbal assembly includes a camera mount receiver in the form of a pair of parallel spaced apart receiver arms.

15. A stabiliser according to claim 14, wherein the stabiliser includes a camera mount carried by the camera mount receiver.

16. A stabiliser according to claim 15, wherein the camera mount receiver includes an orientation indicator.

17. A stabiliser according to claim 1, wherein the proximal end of the first pair of arms is connected directly or indirectly to a handle assembly.

18. A stabiliser according to claim 17, wherein the proximal end of the first pair of arms is rotatably coupled to the handle assembly, whereby the vertical movement stabiliser assembly is rotatable relative to the handle assembly.

19. A stabiliser according to claim 18, wherein the rotatable coupling includes one or more biasing elements arranged to bias the vertical movement stabiliser assembly to a rotational rest position relative to the handle assembly.

20. A stabiliser according to claim 17, wherein the handle assembly includes an accessory mounting plate.

21. A stabiliser according to claim 1, wherein the distal end of the second pair of arms is connected to a 3-axis gimbal assembly; the 3-axis gimbal assembly includes three rotary actuators, wherein each actuator is arranged to rotate about a respective one of the mutually orthogonal axes; the 3-axis gimbal assembly includes one or more frame elements located between each of the rotary actuators, wherein the frame elements connect the rotary actuators and maintain them in their correct orientation; the proximal end of the first pair of arms is connected directly or indirectly to a handle assembly; and wherein the frame elements and the handle assembly are both hinged such that the stabiliser has an operational configuration and a storage configuration, wherein in the storage configuration, the stabiliser folds substantially flat.

22. A stabilised camera mount including a camera mount arranged to receive a camera coupled to a stabiliser according to claim 1.

23. A stabilised camera system including a stabilised camera mount according to claim 22, and a camera secured to the camera mount.

24. A stabilised camera system according to claim 23, wherein the system further includes a monitor.

25. A stabilised camera system according to claim 23, wherein the stabilised camera mount is hinged such that it has an operational configuration and a storage configuration, wherein in the storage configuration, the stabilised camera mount is in a substantially flat configuration and the camera is secured to the camera mount.

26-30. (canceled)

31. A stabilised camera mount including a stabiliser assembly, a mounting bracket for a camera and a 2-dimensional adjustment bracket arranged to balance the mounting bracket relative to the stabiliser assembly, wherein the stabiliser assembly is adapted to maintain the mounting bracket in a plane parallel to a reference plane and the adjustment bracket includes a first element which defines one or more tracks and a second element which includes a locating portion adapted to be secured within the track, wherein the first element of the adjustment bracket has an X axis which lies parallel to the roll axis of the stabiliser assembly and has a Y axis which lies parallel to the pitch axis of the stabiliser assembly and the or at least one of the tracks is angled with respect to the X and Y axes.

32. A stabilised camera mount according to claim 31, wherein the stabiliser assembly is a 3-axis gimbal assembly which is arranged to counter rotation of the stabiliser in three mutually orthogonal axes.

33. A stabilised camera mount according to claim 31, wherein the stabiliser assembly further includes a vertical movement stabiliser assembly as defined in claim 1.
